(19) United States
(12) Patent Application Publication
(10) Pub. No.: US 2015/0317404 A1
(43) Pub. Date: Nov. 5, 2015

(54) Accessing Content in a Rich Internet Application

(71) Applicant: THUNDERHEAD LIMITED, Hertfordshire (GB)

(72) Inventor: Matthew HIBBS, Elstree, Hertfordshire (GB)

(73) Assignee: THUNDERHEAD LIMITED, Elstree, Hartfordshire (GB)

(21) Appl. No.: 14/654,047

(22) PCT Filed: Dec. 20, 2013
(86) PCT No.: PCT/GB2013/053399

§ 371 Date: Jun. 19, 2015

(30) Foreign Application Priority Data
Dec. 20, 2012 (GB) 1223081.9

(51) Int. Cl. G06F 17/30; G10L 13/00

(52) U.S. Cl. CPC G06F 17/30893; G10L 13/00

(57) ABSTRACT

A computer implemented method for accessing content is a rich internet application, the rich internet application being suitable for execution in an application runtime environment operating with a web browser on a computer system, and the content being stored in a data structure in the rich internet application, the method comprising copying the content to at least one field in a web page accessed by the web browser such that the content is accessible via the at least one field in the web page.

### FIELD OF THE INVENTION

The present invention relates to accessing content in a rich internet application. In particular, it relates to improvements to the accessibility of rich internet application content.

### BACKGROUND OF THE INVENTION

Centrally hosted web applications offer many benefits for businesses and users. Web applications provide for centralised development, deployment and maintenance. Cloud based services and Software as a Service (SaaS) offerings can be deployed as web applications, with service providers installing, deploying and maintaining the software centrally. Benefits for users can include flexibility, scalability, reduced capital costs, robustness, centralised support, assured performance, central storage of files and data, central security and data integrity.

On the other hand, desktop applications which execute on local computer systems can provide a flexible user experience with sophisticated, powerful and intuitive user interfaces including features that exceed those available with standardised web technologies such as HTML. To achieve the benefits associated with web applications with the sophistication of desktop applications, rich internet applications (RIAs) can be deployed. RIAs are web applications using technologies that extend beyond the defined standardised web facilities to provide richer functionality similar to desktop applications. RIAs can provide the benefits of a web application combined with the user experience and interactivity of a local desktop application.

Web browsers support standardised web technologies including HTML and often do not include support for the many and varied types of RIA technology. To provide RIA support at a client computer system, additional software is normally installed to operate in addition to, or in conjunction with, a web browser to receive and render RIA applications. Such additional software can include a virtual machine, runtime environment, local media player, browser plugin or similar. Such additional software is hereinafter referred to as a runtime environment.

Examples of RIA technology include JavaScript, Java and JavaFX (Java and JavaFX are registered trademarks of Oracle.) Java and JavaFX allow for the development and deployment of web applications that run across a wide variety of devices and provide rich dynamic functionality including desktop-like user interface controls and interactivity. To render Java and JavaFX web application client software, a local computer system requires an installed Java virtual machine software component as a runtime environment. The Java virtual machine is operable, alone or in conjunction with a browser, to render a Java or JavaFX client application as part of a web application.

Another example of RIA technology is Adobe Flash (Adobe and Flash are registered trademarks of Adobe.) Flash content can include rich, dynamic and interactive client software and media such as audio and video. To render Flash content for a web application a local computer system requires the installation of a Flash player as a runtime environment.

Yet another example of RIA technology is Microsoft Silverlight (Microsoft and Silverlight are registered trademarks of Microsoft.) Silverlight requires a web browser plugin as a runtime component to render Silverlight client content.

When developing and deploying software applications, including web applications, it is desirable to ensure the accessibility of the application to users with sensory impairment, such as users with a sight or auditor impairment. In some circumstances, ensuring such accessibility is a requirement, such as the requirement on US Federal agencies to ensure software solutions are accessible to the disabled by virtue of the Section 508 amendment to the US Rehabilitation Act of 1973. The requirements of Section 508 apply to all Federal agencies when they develop, procure, maintain, or use electronic and information technology. The requirement is consequently passed on to agencies developing and supplying software and services and such providers are cognisant of the requirements of Section 508 in their development and deployment activities.

One technology that assists in Section 508 compliance is screen reader technology. A screen reader is a software and/or hardware component that retrieves content or information about content presented in a user interface such that the content can be presented in an accessible form for sensory impaired users. The information is presented in an accessible form using an accessible output generator, such as a text-to-speech converter, a speech synthesiser, a Braille output device, sound output or other output suitable for assisting an impaired user. In addition to being applicable to users with sensory impairments, such technology is also advantageous for illiterate, dyslexic or learning disabled users.

Screen readers interoperate with software applications through an accessibility application programming interface (API) such as Microsoft's Active Accessibility (MSAA), IAccessible2 from the Linux Foundation or the OS X Accessibility Protocol (OS X is a trademark of Apple.) To provide effective accessibility enhancements, a screen reader and a software application must be specifically developed to cooperate using such native APIs, and thus there is a tight coupling between the software application and the screen reader.

Web browsers can be adapted or configured to cooperate with screen readers using an accessibility API and share web content such as web page information including HTML with screen readers. In this way a screen reader is able to interpret HTML content and provide accessibility enhancements such as text-to-speech for a user. However, where RIA applications are rendered by a web browser using RIA runtime environments, the web browser is unable to communicate content or information about contact to a screen reader since the content of the RIA is not in a HTML form and is not readily accessible to the web browser. In contrast, the content for RIA applications is rendered by a runtime environment such as a virtual machine or browser plugin. Accordingly, a screen reader cannot access content or information about content in a RIA applications from a browser.

To provide accessibility enhancements for a RIA web application using a screen reader it is necessary for the RIA web application to include support for a native accessibility API. Such support can be at least partly provided through the runtime environment for the RIA such that the RIA web application can cooperate with a screen reader. However, this introduces a tight coupling between the RIA and the screen reader and imposes further burdens when developing a RIA and associated runtime environment. Also, such an approach introduces a separation between accessibility facilities for accessing a web page rendered by a browser and accessibility facilities for accessing RIA applications that may be embedded in the web page. Such separation is unhelpful and detracts from usability which is a key concern for sensory impaired users. Yet further, RIAs need to be developed to take advantage of accessibility facilities provided by a RIA runtime environment, such as by identifying content for sharing with screen readers and ensuring such content is kept up to date as content dynamically changes in an RIA.

It would therefore be advantageous to provide accessibility enhancements for RIAs without the aforementioned disadvantages.

### SUMMARY OF THE INVENTION

The present invention accordingly provides, in a first aspect, a computer implemented method for accessing content in a rich internet application, the rich internet application being suitable for execution in an application runtime environment operating with a web browser on a computer system, and the content being stored in a data structure in the rich internet application, the method comprising copying the content to at least one field in a web page accessed by the web browser such that the content is accessible via the at least one field in the web page.

Thus embodiments of the invention provide access to RIA content in a manner suitable for a user having sensory impairment via a standard assistive technology such as a screen reader using a standard existing accessibility API such as Microsoft's Active Accessibility (MSAA), IAccessible2 or the OS X Accessibility Protocol. The accessibility mechanism is consistent for content in the RIA and other content that may be rendered in the web page accessed by the web browser. Further, the RIA need not include accessibility features that tightly couple the RIA to any particular assistive technology or API each as proprietary browser accessibility functions.

Preferably the method further comprises an assistive technology software component accessing the at least one field in the web page so as to render the content in a form suitable for access by a sensory impaired user.

Preferably the assistive technology software component is a screen reader software component.

Preferably the content is rendered as audio using a text-to-speech converter.

Preferably the content includes data and information indicating at least one formatting characteristic of the content.

Preferably the at least one formatting characteristic includes at least one of: a style, structure, format and configuration of the data.

Preferably the content includes media content.

Preferably the assistive technology software component includes accessible output generator for generating output suitable fox access by a sensory impaired user, the accessible output generator including at least one of: a text-to-speech converter, a speech synthesiser and a tactile output device.

The present invention accordingly provides, in a second aspect, a content accessibility apparatus for accessing content in a rich internet application, the rich internet application being suitable for execution in an application runtime environment operating with a web browser on a computer system, and the content being stored in a data structure in the rich internet application, the apparatus comprising a field updater component for copying the content to at least one field in a web page accessed by the web browser such that the content is accessible via the at least one field in the web page.

The present invention accordingly provides, in a third aspect, an apparatus comprising: a central processing unit; a memory subsystem; an input/output subsystem; and a bus subsystem interconnecting the central processing unit, the memory subsystem, the input/output subsystem; and the apparatus as described above.

The present invention accordingly provides, in a fourth aspect, a computer program element comprising computer program code to, when loaded into a computer system and executed thereon, cause the computer to perform the steps of a method as described above.

### BRIEF DESCRIPTION OF THE DRAWINGS

A preferred embodiment of the present invention is described below in more detail, by way of example only, with reference to the accompanying drawings, in which:

FIG. 1 is a block diagram of a computer system suitable for the operation of embodiments of the present invention;

FIG. 2 is a component diagram of a rich internet application accessibility system in accordance with a preferred embodiment of the present invention;

FIG. 3a is a flowchart of a method for rendering a rich internet application in accordance with a preferred embodiment of the present invention;

FIG. 3b is a flowchart of a method of the accessibility field updater of FIG. 2 in accordance with a preferred embodiment of the present invention;

FIG. 3c is a flowchart of a method of the assistive technology software component of FIG. 2 in accordance with a preferred embodiment of the present invention; and

FIG. 4 is a component diagram of a rich internet application accessibility system in use in accordance with a preferred embodiment of the present invention.

### DETAILED DESCRIPTION OF THE PREFERRED EMBODIMENTS

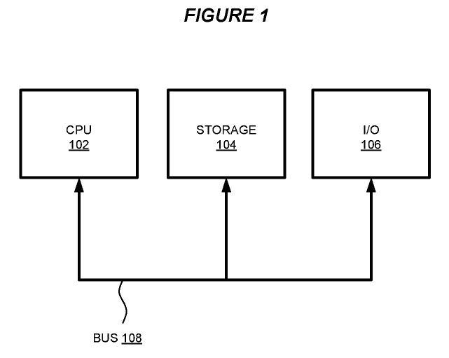

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 includes a keyboard, a mouse, a display (such as a monitor) and a network connection.

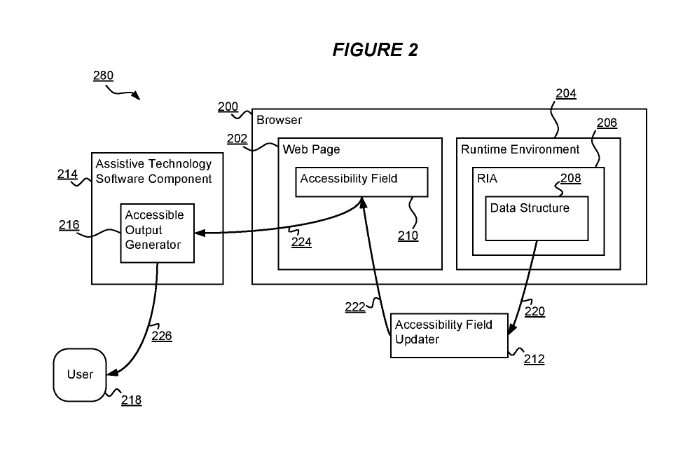

FIG. 2 is a component diagram of a rich internet application (RIA) accessibility system 280 in accordance with a preferred embodiment of the present invention. The RIA accessibility system 280 is an arrangement of software, hardware or software and hardware elements for providing accessibility facilities to a user 218. In particular, the RIA accessibility system 280 is suitable for providing access to application content in an RIA 206 by a user 218 having sensory impairment, such as visual or auditory impairment.

The RIA accessibility system 280 includes a web browser 200. The web browser 200 is a software and/or hardware component operable to receive web page information such as HTML or augmented HTML web page documents from a web server. Example web browsers include Internet Explorer™ provided by Microsoft™ Corporation (Internet Explorer and Microsoft are Trademarks or Registered Trademarks of Microsoft Corporation); Chrome™ provided by Google™ (Chrome and Google are Trademarks or Registered Trademarks of Google); Firefox™ provided by Mozilla™ (Firefox and Mozilla are Trademarks or Registered Trademarks of Mozilla Inc.); Opera™ provided by Opera Software™ (Opera is a Trademark or Registered Trademark of Opera Software); Safari™ provided by Apple ™ Inc. (Safari and Apple are Trademarks or Registered Trademarks of Apple Inc) or any other web browser as will be known to those skilled in the art.

In use, the web browser 200 receives web page documents such as web page 202 from a web server. Web page 202 is, for example, an HTML document including one or more web page elements. Each web page element is an individual component of the web page 202 having an identifier and attributes. For example, a web page defined in HTML can include elements such as: container elements (e.g. “DIV”); textual elements (e.g. “H1”, “SMALL”); image elements (e.g. “IMG”); anchor elements (e.g. “A”); as well as other elements such as user interface controls, dynamic elements, embedded media elements including audio or video, embedded software such as Java applets or native controls.

The web page 212 includes an accessibility field 210 and a reference to an RIA 206. Accessibility field 210 is a field of the web page suitable for storage of content such as data, information or media from the RIA 206 as will be described below. The accessibility field 210 is accessible to the web browser 200 such that data stored in the accessibility field 210 can be retrieved by the browser 200. For example, the accessibility field 210 is an HTML field of the web page 202. Preferably, the accessibility field 210 is adapted to be rendered out of sight of a user of the web page 202, such as at a location not normally visible to a user of the web page 202 including a location off-screen. Alternatively, the accessibility field 210 can have attributes that cause the field 210 to be invisible, not rendered or otherwise not displayed as part of web page 202. Numerous possible approaches can be employed to ensure the accessibility field 210 is not visible. For example, where the accessibility field 210 is a HTML field, parameters such as: “visibility:hidden”; “display:none”; “width:0 px;height:0 px”; and/or “text-indent:−1000 px” can be employed. Alternatively or additionally, the field can be positioned off-screen using absolute position parameters in HTML.

In a preferred embodiment, the accessibility field 210 is suitable for being accessed via an accessibility API such as such as Microsoft's Active Accessibility (MSAA), IAccessible2 from the Linux Foundation or the OS X Accessibility Protocol.

Such access to the accessibility field 210 can be via the browser 200 which may be operable to interface via one or more such accessibility APIs.

RIA 206 is a software component executing in a runtime environment 204. For example, the RIA 206 can be a client software application provided by a web server such as a Java, JavaFX, Flash or Silverlight application. The runtime environment 204 is a software and/or hardware component executing within, alongside, in communication with or in conjunction with the web browser 200. The runtime environment 204 provides facilities required for the execution of the RIA 206. For example, the runtime environment 204 is a software component native to a computer system that is operable to receive and execute RIA 206. Runtime environment 204 can include a virtual machine, such as a Java virtual machine, or other mechanism for interpreting and executing executable instructions comprised in RIA 206. For example, RIA 206 can include machine code, bytecode or other expressions of executable function that are interpretable by the runtime environment 204. Alternatively, the runtime environment 204 can be a “player” software component such as a Flash player or a media player operable to receive and render RIA 206.

In the preferred embodiment, the runtime environment 204 is an adjunct, extension or plugin to the web browser 200. While the runtime environment 204 is illustrated as being comprised within the browser 200 it will be appreciated by those skilled in the art that the runtime environment 204 can be provided separate to the browser 200. For example, the runtime environment 204 can be provided as a component installed to an operating system of a computer system in communication with browser 200.

While the RIA 206 is described as being reference by the web page 202 it will be apparent to those skilled in the art that RIA 206 may be embedded, identified or otherwise indicated in web page 202. For example, the RIA 206 may be referenced by the web page 202 using an “object”, “applet” or “embed” HTML tag. Such references can include an indication of a type of the RIA 206, such as the application type which can be specified as a MIME type.

RIA 206 includes content stored generally in data structure 208. It will be apparent to those skilled in the art that multiple, many or numerous data structures can be provided by or for RIA 206 in which data including content is stored. Content includes information, data or media stored by or for the RIA 206. For example, where RIA 206 renders textual, graphical, multimedia or other information on a display of a computer system, such information can constitute content stored in data structure 208. Data structure 208 can be a simple data structure, such as a single data item of specific or non-specific type (such as numeric, textual or unspecified type). Alternatively, data structure 208 can be a multi-element, multi-field or complex data structure, such as a record including numerous and potentially nested elements, fields or items. In some embodiments, data structure 208 includes other, nested, data structures. Thus, in this way content associated with the RIA 206 such as information, data or media presented by the RIA 206 via a user interface of the RIA 206, is stored in data structure 208. Examples of such content can include rich text, images, numerical information or information relating to user interface controls including control names, control types (e.g. combobox, edit field, menu item, button etc), control status (e.g. active, inactive, visible, editable, populated, unpopulated etc). Additionally or alternatively, content can include information relating to the layout, structure, content or navigation of a user interface associated with or provided by the RIA 206. For example, a location of a mouse pointer, an entry field caret, a selected menu item, a size or state of a window or other control, a number of or enumerated list of items in a list control etc. Further additionally or alternatively, content can include information relating to a state of the RIA 206, such as a loading state (e.g. percentage loaded), a visibility state, an active state etc. In yet a further addition or alternative, content can include information selected, indicated or identified by a user, such as text selected in an entry field or menu items selected in a drop down menu. Such information can be stored in data structure 208.

The RIA accessibility system 280 further includes an accessibility field updater 212 as a software and/or hardware component for updating a value, content or data stored in the accessibility field 210. The accessibility field updater 212 is operable to retrieve data, information or media stored in the data structure 208 for storage in the accessibility field 210 in web page 202. For example, the accessibility field updater 212 can update the accessibility field 210 by modifying a document object model (DOM) for the web page 202. For example, where the web page 202 is comprised of HTML, the DOM of the web page 202 will comprise addressable objects, including the accessibility field 210, which can be modified by reference to web page element identifiers. For example, an addressable object for a web page element can be obtained by JavaScript using the “getElementById” call, passing the element identifier as a parameter. The resulting object reference returned by such a call can be used as a basis for invoking methods and modifying object attributes. For example, the “getAttribute” and “setAttribute” JavaScript calls can be used to obtain and set attribute states for a DOM object. In this way the accessibility field updater 212 can be operable to modify the accessibility field 210.

Where data structure 208 is a simple data structure, such as a single data item, a single accessibility field 210 is employed to store content from data structure 208. Where the data structure 208 is a nested, multi-field or otherwise complex data structure, multiple fields can be employed in place of accessibility field 210. In this way content from the RIA 206 is provided outside the RIA 206 and the runtime environment 204 by way of the accessibility field 210. The accessibility field updater 212 can be operable to update the accessibility field 210 routinely at predetermined, configurable or variable time intervals. Alternatively, the accessibility field updater 212 can be operable to update the accessibility field 210 on request, such as by request of the user 218. In a further alternative, the accessibility field updater 212 can be operable to update the accessibility field 210 in response to the satisfaction of a condition or one or more criteria, such as when data structure 208 or data stored in data structure 208 is modified, refreshed or updated.

While the accessibility field updater 212 is illustrated as being external to the browser 200, RIA 206 and runtime environment 204, it will be appreciate by those skilled in the art that the accessibility field updater 212 may be implemented wholly or partially as a function of one or more of these components. The accessibility field updater 212 is operable to access data structure 208 and so accessibility field updater 212 can be implemented as a function of RIA 206 or a function of the runtime environment 204 with which RIA 206 executes. Further, accessibility field updater 212 is operable to update the accessibility field 210 and accordingly the accessibility field updater 212 can be partially implemented as part of, or in cooperation with, browser 200, such as a function of browser 200, a plugin or extension to browser 200, or a script for execution by browser 200. Such a script can be stored in the web page 202, such as a JavaScript. In a further alternative, the accessibility field updater 212 is implemented in part by the RIA 206 or runtime environment 204 and in part by the browser 200 or as a plugin or extension to browser 200.

The RIA accessibility system 280 further includes an assistive technology software component 214. The assistive technology software component 214 is a component operable to access the accessibility field 210 so as to render the contents of the accessibility field 210 in a form suitable for access by a sensory impaired user. Since the accessibility field updater 212 copies content stored in data structure 208 to the accessibility field 210, the assistive technology software component 214 thus effectively renders content in RIA 206 in a form suitable for access by a sensory impaired user, such rendering being achieved via accessibility field 210.

While the assistive technology software component 214 is described as a software component, it will be apparent to those skilled in the art that the assistive technology software component 214 could alternatively be embodied as a hardware component or a combined software and hardware component suitable for accessing the accessibility field 210. Preferably, the assistive technology software component 214 is operable via an accessibility API such as those previously described. The assistive technology software component 214 can be a screen reader component such as JAWS (JAWS is a registered trademark of Freedom Scientific) or any other suitable software component for accessing the accessibility field 210.

The assistive technology software component 214 preferably includes an accessible output generator 216 as a software or hardware component suitable for generating output 226 suitable for access by a sensory impaired user. For example, the accessible output generator 216 can include a text-to-speech converter, a speech synthesiser, a user interface description facility for describing attributes of a user interface, a caption generator, a tactile output device such as a Braille output device or any other accessible output 226 suitable for assisting users having sensory impairment as will be apparent to those skilled in the art. The output 226 generated by the accessible output generator 216 is derived from, or based on the contents of the accessibility field 120 which, in turn, is copied from data structure 208 in the RIA 206. Thus, the accessible output 226 provides content from the RIA 206, or information about content from the RIA 206, in a form or manner that is suitable for consumption by a user having sensory impairment. For example, the accessible output 226 can be an audible representation of the content stored in data structure 208 such as may be generated from a text-to-speech function. Alternatively, the accessible output 226 can be an audible description of one or more characteristics of the content stored in data structure 208. Such characteristics can include, for example, a format, style, typeface or size of rich text content stored in data structure 208. Similarly, such characteristics can include, for example, a state, size type or label of a user interface control included in the content stored in data structure 208.

Thus, in use, user 218 uses the web browser 200 to navigate to a web page 202 including a reference to RIA 206. The RIA 206 is rendered by the runtime environment 204 and includes content stored in data structure 208. The accessibility field updater 212 copies 220, 222 content from the data structure 208 to the accessibility field 210 for retrieval 224 by the assistive technology software component 214. The accessible output generator 216 generates accessible output 226 for consumption by the user 218 providing content or information about content of the RIA 206 stored in data structure 208.

In this way, content from the RIA 208 is available to an assistive technology software component 214 such as a screen reader via existing standard accessibility mechanisms, such as accessibility APIs, without a need for the RIA 206 or runtime environment 204 to provide bespoke, proprietary or dedicated facilities for interfacing with assistive technology software component 214. Further, the use of the accessibility field 210 to provide a copy of content in the web page 202 and content in the referenced RIA 206 are available to assistive technology software component 214 in combination via web page 202. Thus, there is no separation between content from the web page 202 and content from the RIA 206 which would detract form the usability of the web page 202 and RIA 206. This advantage is particularly acute for users having sensory impairment where such separation can constitute a considerable challenge or hindrance to the usability of a combined web page and RIA software application.

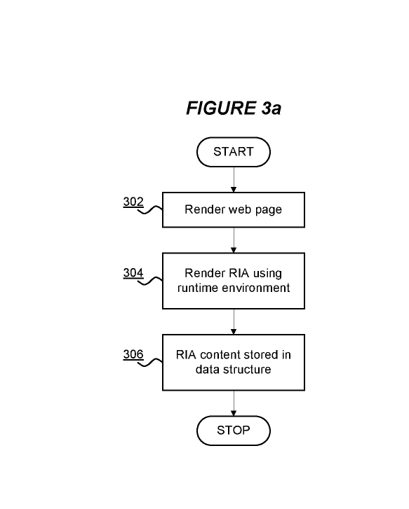

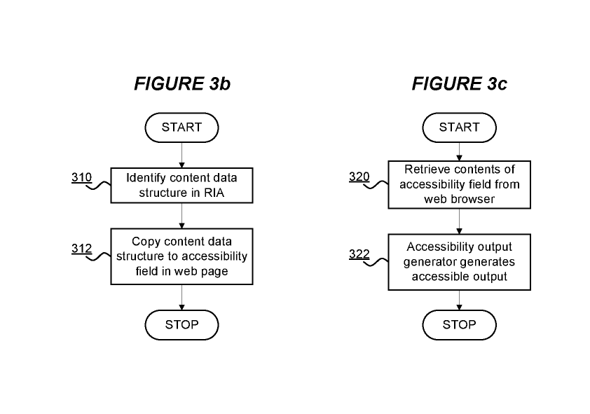

FIG. 3a is a flowchart of a method for rendering an RIA application 208 in accordance with a preferred embodiment of the present invention. Initially, a step 302, the browser 200 renders the web page 202. At step 304 an RIA 206 reference by the web page 202 is rendered using the runtime environment 204. At step 306, content in the RIA 206 is stored in the data structure 208.

FIG. 3b is a flowchart of a method of the accessibility field updater 212 of FIG. 2 in accordance with a preferred embodiment of the present invention. Initially, at step 310, the accessibility field updater 212 identifies content stored in data structure 208 of the RIA 206. Subsequently, at step 312, the accessibility field updater 212 copies content from data structure 208 to the accessibility field 210.

FIG. 3c is a flowchart of a method of the assistive technology software component 214 of FIG. 2 in accordance with a preferred embodiment of the present invention. Initially, at step 320, the assistive technology software component 214 retrieves the contents of the accessibility field 210 from the web page 202, such as via an accessibility API. Subsequently, at step 322, the accessibility output generator 216 generates accessible output 226 suitable for a user having sensory impairment.

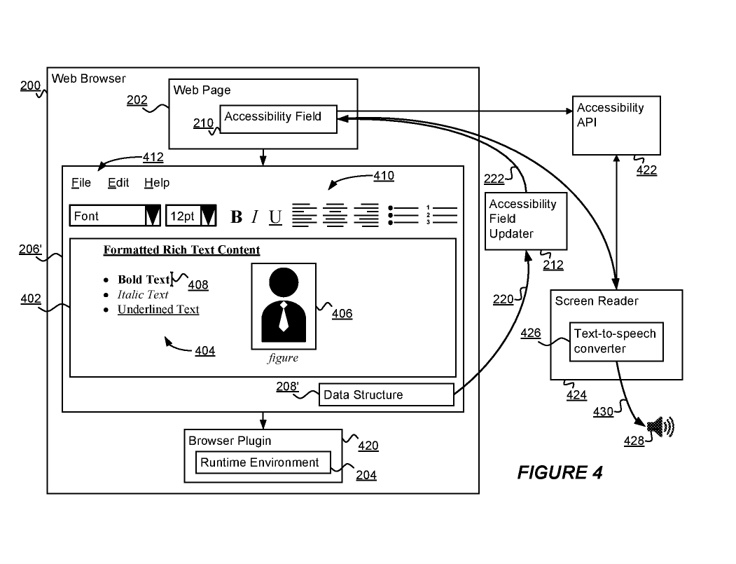

FIG. 4 is a component diagram of an RIA accessibility system in use in accordance with a preferred embodiment of the present invention. Many of the features of FIG. 4 are identical to those described above with respect, to FIG. 2 and a detailed explanation of these features will not be repeated here. An RIA 206′ executes in runtime environment 204 configured as a browser plugin 420 for the web browser 200. RIA 206′ includes a rich text editing web application, such as a web based, cloud or SaaS word processor application such as can be rendered using a Flash, Silverlight or Java runtime environment. The RIA 206′ has sophisticated, complex and rich user interface features including a menu 412 and toolbar 410. A rich text entry field 402 is provided for a user to create and edit rich text 404 including other media features such as image 406. A caret 408 is used to navigate, select, enter and edit content in the entry field 402.

RIA 206′ includes e data structures 208′. Data structure 208′ stores data relating to a user selection in the rich text entry field 402, such as a selection highlighted by the user using the caret 408. For example, where the user selects rich text 404, data structure 208′ stores the rich text content 404 including textual content, format, style, font, size, layout, paragraph characteristics, line spacing, bulleted list information and any other relevant content and characteristics for rich text 404. In an alternative example, where the user selects image 406, data structure 208′ stores data relating to image 406 including image data such as bitmapped or vector image information, dimensions, position and any metadata such as descriptive information for image 406.

The blooper 200 is operable to cooperate with assistive technology software components via accessibility API 422. One such assistive technology software component is illustrated in FIG. 4 as screen reader 424, such as JAWS. Screen reader 424 includes a text-to-speech converter as a hardware and/or software component for converting text stored in text format into audible speech signal 430 using, for example, a speech synthesiser. The audible speech signal 430 can be an audio data stream, audio file or analogue audio signal suitable for being output by an audio output device 428 such as a speaker.

In an example of the arrangement of FIG. 4 in use, a user selects rich text content 404 using caret 408 for output to the user in a form suitable for a sensory impaired user. The accessibility field updater 212 retrieves 220 the selected content from data structure 208′ and copies 222 the selected content to the accessibility field 210. The screen reader 424 subsequently accesses 224 the contents of the accessibility field 210 corresponding to the selected rich text content 404 using the accessibility API 422. The text-to-speech converter 426 is operable to convert the contents of the accessibility field 210 into an audible speech signal 430 for output by the audio output device 428. In this way, user selections in the rich text entry field 402 of the RIA 206′ can be expressed in a manner suitable for a user having sensory impairment via a standard screen reader 424, such as JAWS, using an existing accessibility API such as Microsoft's Active Accessibility (MSAA), IAccessible2 or the OS X Accessibility Protocol. The accessibility mechanism is consistent for content in the RIA 206′ and other content that may be rendered in the web page 202, and the RIA 206′ need not include accessibility features that tightly couple the RIA 206′ to any particular assistive technology such as proprietary browser accessibility functions.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such, as compact disk or digital versatile disk etc., and the processing device utilises the program or part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice chat new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method, for accessing content in a rich internet application, the rich internet application being suitable for execution in an application runtime environment operating with a web browser on a computer system, and the content being stored in a data structure in the rich internet application, the method comprising copying the content to at least one field in a web page accessed by the web browner such that the content is accessible via the at least one field in the web page.

2. The method of claim 1 further comprising an assistive technology software component accessing the at least one field in the web page so as to render the content in a form suitable for access by a sensory impaired user.

3. The method of claim 2 wherein the assistive technology software component is a screen reader software component.

4. The method of claim 3 wherein the content is rendered as audio using a text-to-speech converter.

5. The method of claim 1 wherein the content includes data and information indicating at least one formatting characteristic of the content.

6. The method of claim 5 wherein the at least one formatting characteristic includes at least one of: a style, structure, format and configuration of the data.

7. The method of claim 1 wherein the content includes media content.

8. The method of claim 2 wherein the assistive technology software component includes accessible output generator for generating output suitable for access by a sensory impaired user, the accessible output generator including at least one of: a text-to-speech converter, a speech synthesiser and a tactile output device.

9. A content accessibility apparatus for accessing content in a rich internet application, the rich internet application being suitable for execution in an application runtime environment operating with a web browser on a computer system, and the content being stored in a data structure in the rich internet application, the apparatus comprising a field updater component for copying the content to at least one field in a web page accessed by the web browser such that the content is accessible via the at least one field in the web page.

10. The apparatus of claim 9 further comprising an assistive technology component for accessing the at least one field in the web page so as to render the content in a form suitable for access by a sensory impaired user.

11. The apparatus of claim 10 wherein the assistive technology component is a screen reader component.

12. The apparatus of claim 9 wherein the content includes data and information indicating at least one formatting characteristic of the content.

13. The apparatus of claim 10 wherein the assistive technology component includes an accessible output generator for generating output suitable for access by a sensory impaired user, the accessible output generator including at least one of: a text-to-speech converter, a speech synthesiser and a tactile output device.

14. An apparatus comprising: a central processing unit; a memory subsystem; an input/output subsystem; and a bus subsystem interconnecting the central processing unit, the memory subsystem, the input/output subsystem; and the apparatus as claimed in any of claims 9 to 13.

15. A computer program element comprising computer program code to, when loaded into a computer system and executed thereon, cause the computer to perform the steps of a method as claimed in any of claims 1 to 8.
